(19) United States
(12) Patent Application Publication
(10) Pub. No.: US 2005/0099679 A1
(43) Pub. Date: May 12, 2005

(54) Microscope especially inverted microscope

(76) Inventors: Lothar Kleinteich, Jena (DE); Horst Bruch, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/398,841

(22) PCT Filed: Oct. 2, 2001
(86) PCT No.: PCT/EP01/11380

(30) Foreign Application Priority Data
Oct. 6, 2000 (DE) 10050-823.5

(51) Int. Cl. G02B 21/00

(52) U.S. Cl. 359/368

(57) ABSTRACT

The invention is directed to a microscope, particularly an inverted microscope, with an incident illumination beam path for fluorescence excitation by means of a fluorescent light source. The fluorescence excitation is carried out by means of a shutter for generating fluorescence excitation, which shutter opens the light path temporarily. In order to reduce the switching time, the shutter is arranged within the illumination optics in an area having a smaller illumination bundle diameter, preferably between the aperture diaphragm and the field diaphragm.

### CROSS-REFERENCE TO RELATED APPLICATIONS

This application claims priority of PCT Application Serial No. PCT/EP01/11380, filed Oct. 2, 2001 and German Application No. 100 50 823.5, filed Oct. 6, 2000, the complete disclosures of which are hereby incorporated by reference.

### BACKGROUND OF THE INVENTION

a) Field of the Invention

The present invention relates to an improvement in an inverted micrsocope.

b) Description of the Related Art

The beam path of an inverted microscope is shown schematically in FIG. 1.

A halogen lamp HAL at the microscope stand MS illuminates an object located on the specimen stage PT via a condenser KO. Located below the specimen stage is an objective turret OR, shown without the objective lenses which are inserted therein, and a reflector RF which is part of a reflector turret, not shown, and which can be switched on to reflect in a fluorescence excitation beam path FS of a light source LF. The imaging beam path AS is deflected in the direction of the eyepiece OK (not shown) of the observer by a deflecting mirror US. Further, a recording beam path AS is provided for photographic recordings.

### OBJECT AND SUMMARY OF THE INVENTION

The primary object of the invention is the improvement of the optically effective switching time of a mechanical shutter used with an inverted microscope.

Accordingly, in accordance with the invention, a microscope, particularly an inverted microscope, comprising an incident illumination beam path for fluorescence excitation by a fluorescent light source, a shutter for generating fluorescence excitation, which shutter opens the light path temporarily, wherein, in order to reduce the switching time, the shutter is arranged inside the illumination optics in an area of a smaller illumination bundle diameter.

### BRIEF DESCRIPTION OF THE DRAWINGS

In the drawings:

FIG. 1 is a schematic representation of an inverted microscope showing the beam path; and

FIG. 2 shows in schematic form the arrangement of the shutter within the microscope illumination optics in accordance with the invention.

### DESCRIPTION OF THE PREFERRED EMBODIMENTS

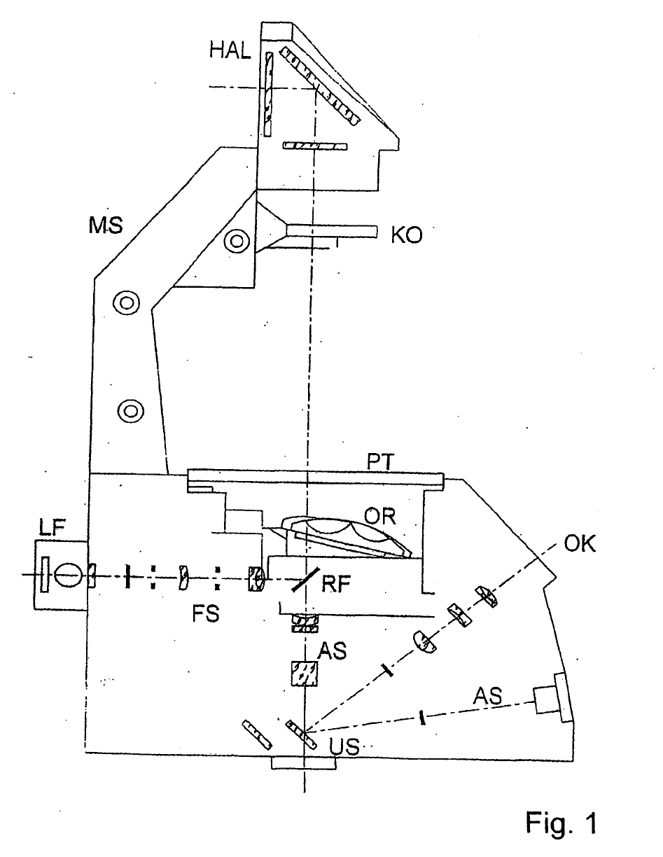

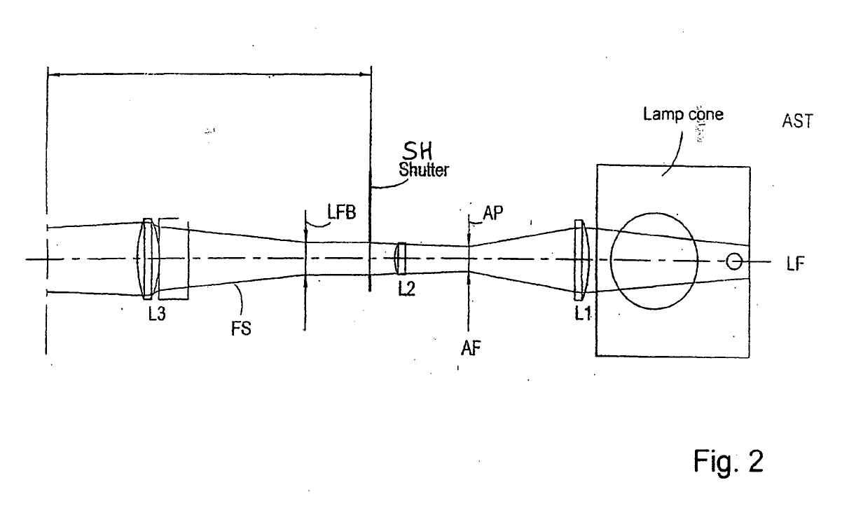

In a reverse view with respect to FIG. 1, FIG. 2 shows the illumination beam path FS with a device cone AST for the light source LF, illumination optics L1-L3, the field diaphragm LFB, and the aperture diaphragm AF.

The light from light source LF, not shown, is imaged to infinity in parallel by means of a collector lens, not shown, and is imaged in the plane of the aperture diaphragm by L1.

A plane conjugate to the field diaphragm is imaged in the plane of the field diaphragm by L1, L2 and is imaged in the exit pupil of the objective by L3 and the objective in OP.

A shutter SH for interrupting the light path is arranged in the beam path between L1 and L3, preferably in the vicinity of the aperture diaphragm but at a slight distance from the latter in an area of a smaller light bundle diameter within the illumination optics.

Since the optically effective switching time, i.e., the time during which the light bundle is released, of a preferably mechanical shutter, for example, an iris diaphragm or blinker switch, is directly proportional to the light bundle diameter to be interrupted, there is a significant reduction of the optically effective switching time, i.e., the opening time, due to the arrangement of the shutter directly inside the illumination optics compared to a shutter arranged outside, e.g., in front of the lens L1 or after the lens L3. Therefore, depending on the switching speed of the mechanical shutter, a switching time of 1 to 10 msec, for example, can be achieved.

This is very important when observing fluorescence and for recording in order to reduce the loading of the specimen.

While the foregoing description and drawings represent the present invention, it will be obvious to those skilled in the art that various changes may be made therein without departing from the true spirit and scope of the present invention.

1. (canceled)

2. A microscope, comprising:
an incident illumination beam path for fluorescence excitation by a fluorescent light source; and
a shutter operable to open the light path temporarily to produce fluorescence excitation in a sample;
wherein, in order to reduce the switching time, said shutter is arranged inside an illumination optics in an area of a smaller illumination bundle diameter.

3. The microscope of claim 2, wherein the illumination optics includes an aperture diaphragm and field diaphragm and the shutter is arranged therebetween.

4. The microscope of claim 2, wherein the microscope is an inverted microscope.

5. An inverted microscope comprising:
a fluorescence excitation light source;
an illumination optics positioned to receive light from the fluorescence excitation light source and pass the received light to an objective lens, the illumination optics having therein an illumination beam path that varies in illumination bundle diameter; and
a shutter positioned inside the illumination optics in an area of a smaller illumination bundle diameter so as to reduce a switching time.

6. The inverted microscope of claim 5, wherein the illumination optics includes an aperture diaphragm and field diaphragm and the shutter is arranged therebetween.
